(19) United States
(12) Patent Application Publication
(10) Pub. No.: US 2003/0094767 A1
(43) Pub. Date: May 22, 2003

(54) Mechanical seal for a cable installed in a corrugated duct

(75) Inventors: Olaf Storaasli, Hickory, NC (US); Robert Jeyaseelan, Hickory, NC (US); Brian Risch, Hickory, NC (US)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/206,195

(22) Filed: Jul. 29, 2002

Related U.S. Application Data
(63) Continuation-in-part of application No. 09/987,970, filed on Nov. 16, 2001, now abandoned.

(51) Int. Cl. H02G 15/013

(52) U.S. Cl. 277/602

(57) ABSTRACT

A seal for sealing the space between a cable and the ends of the corrugated conduit. The seal includes a seal body including a base portion, an engagement portion attached to the base portion and being insertable in the space between the cable and the conduit, and a retainer disposed on the engagement portion for engaging at least one of the corrugations of the conduit. The base portion preferably has a groove for retaining an O-ring such that the O-ring tightly circumscribes the cable to create a seal. The retainer preferably includes helical threads disposed on the outside surface of the engagement portion. Alternatively, however, the retainer can include a rib which engages a corrugation or one or more protrusions which engages a corrugation. Further, the seal body is preferably split into two halves so that it can be installed onto the cable without requiring access to the end of the cable. In addition, the seal body may include two halves interconnected by a hinge so that it is one-piece. Further, as a substitute for the O-rings, the seal may include internal ribs made of a soft material which seal the cable.

### TECHNICAL FIELD

The present invention relates to a sealing device for sealing a cable provided in a corrugated conduit or the like and a method for accomplishing the same.

### BACKGROUND

There is a recent trend to install cables in sewers. The preferred non-intrusive method is achieved by installing corrugated conduit in the sewers and pulling the cable through the conduit. In order to allow access to the cable along the sewer line, such as in the manholes, the corrugated conduit generally extends from manhole to manhole. When the cable is pulled through the conduit, the cable exits one conduit on one side of the manhole and enters the next conduit at another side of the manhole such that a portion of the cable between the two conduits is accessible.

The problem with this arrangement is that there is no seal to prevent water, sewage or the like from entering the space between the cable and the conduit at the exposed end of the conduit. Thus, the cable may be subjected to harmful chemicals resident in sewer systems. Corrosion and hydrogen generation may occur which can be detrimental to the performance of the cable.

### SUMMARY OF THE INVENTION

The present invention is designed to overcome this problem. According to one aspect of the invention, a seal is provided for sealing the space between the cable and the ends of the corrugated conduit. The seal includes a seal body including a base portion, an engagement portion attached to the base portion and being insertable in the space between the cable and the conduit, and a retainer disposed on the engagement portion for engaging at least one of the corrugations of the conduit. The base portion preferably has one or more grooves for retaining a corresponding number of O-rings such that the O-rings tightly circumscribe the cable to create a seal.

The retainer preferably includes helical threads disposed on the outside surface of the engagement portion. Alternatively, however, the retainer can include a rib which engages a corrugation or one or more protrusions which engages a corrugation. Further, the seal body is preferably split into two halves so that it can be installed onto the cable without requiring access to the end of the cable. Further, if the conduit does not have corrugations, the seal may be designed so that it does not have the retainer. In this case, the seal can be held in place by friction as a result of the tapered engagement portion that would be press-fit in the space between the conduit and the cable. According to a further aspect of the invention, the body may include two body portions and a hinge interconnecting the two body portions. The seal defines an opening therein through which said cable passes and the base portion of the seal may include an internal rib that contacts the cable to act as a seal as a substitute, or in addition to, the O-ring. Thus, the seal can be one-piece. It may be preferable to include an alignment device for aligning said body portions when said body portions are pivoted with respect to said hinge to enclose said cable. The alignment device may include a pin on one of said body portions and a hole in another of said body portions for receiving said pin.

The invention also includes a method of sealing the space between the cable and the conduit using the seal.

### BRIEF DESCRIPTION OF THE DRAWINGS

FIG. 1 is a cross-sectional view of the seal according to a first embodiment of the present invention;

FIG. 2 is an end view of the seal according to the first embodiment of the invention;

FIG. 3 is an end view of the seal according to a second embodiment of the invention;

FIG. 4 is an end view of the seal according to a third embodiment of the invention;

FIG. 5 is an end view of the seal according to a fourth embodiment of the invention;

FIG. 6 is a cross-sectional view of the seal according to yet a further embodiment of the invention; and

FIG. 7 is a cross-sectional view of still a further embodiment of the invention.

### DETAILED DESCRIPTION

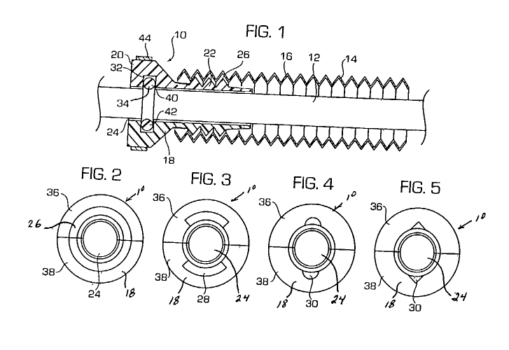

A preferred embodiment of the invention will now be described with reference to FIGS. 1 and 2.

As noted above, the seal 10 is insertable into an annular space between a cable 12 and a conduit 14 having corrugations 16 so that water, sewage and the like cannot penetrate the space.

The seal 10 includes a seal body 18 having a base portion 20 and a tapered engagement portion 22 that extends from the base portion 20. The seal body 18 also has a longitudinal through hole 24 for receiving the cable 12, as discussed below. The engagement portion 22 has a retainer 26 for engaging a corrugation 16 of the conduit 14 in order to secure the seal body 18 to the conduit 14, as illustrated in FIG. 1.

According to the preferred embodiment, the retainer 26 is in the form of external threads so that the engaging portion can be screwed into the corrugated conduit 14. However, the invention is not limited in this respect. For example, the retainer could include one or more ribs 28 that extend from the engagement portion, as illustrated in FIG. 3, or a one or more projections 30, as shown in FIGS. 4 and 5. Further, the projections can have a round end as shown in FIG. 4 or a pointed end (e.g., V-shaped), as shown in FIG. 5.

The base portion 20 has a groove 32 extending around the inner surface thereof for retaining an O-ring 34. This ensures a tight seal between the seal body 18 and the cable 12. Again, however, the invention is not limited to requiring an O-ring. For example, a seal ring could be secured to the rear end of the seal body 18 in such a manner that it presses against the cable. Also, there could be a plurality of grooves for receiving a corresponding number of O-rings.

Also, although it is preferred that the seal body 18 be made of plastic, it could alternatively be made of other materials, such as rubber, that may provide better sealing with the cable.

When the end of the cable is accessible, the seal body 18 can be one-piece since it can be slipped over the end of the cable. However, in most instances, the end of the cable will not be accessible in which case the seal body 18 should preferably be made out of two halves 36 and 38. Correspondingly, the O-ring 34 should also be split into two halves 40 and 42. Naturally, the invention is not intended to be limited in this respect. For example, it is possible that the seal body 18 and the O-ring, or rings, could be split into three or more pieces.

Although not necessary, a clamp 44 may be provided for holding the two halves 36 and 38 together. The clamp may be in the form of an elastic band that circumscribes the base portion 20 of the two halves, as illustrated in FIG. 1. Again, however, it should be emphasized that the clamp is not necessary since the two halves are automatically held together after they have been inserted into the conduit.

After the cable has been pulled through the conduit, the two seal halves 36 and 38, having respective O-ring halves 40 and 42 retained in the O-ring groove 32, are slipped over the cable and held together. Thereafter, the seal body 18 is rotated so that the retainer, e.g., the threads 26, engages the corrugations 16 of the conduit 14. Thus, the seal body 18 can be easily engaged with the conduit and held in place with the O-ring 34 tightly retained against the cable 12.

The seal of the present invention can be used with any type of cable that is disposed inside corrugated conduit, including, for example, copper cable and optical fiber cable.

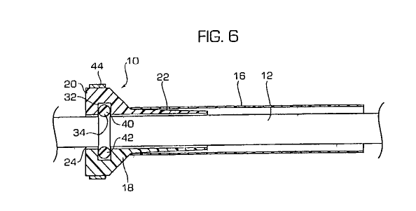

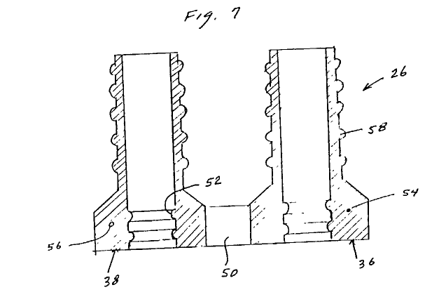

FIG. 6 shows yet another embodiment of the present invention in which the seal 10 can be used to seal an end of a conduit 16 that does not have corrugations. In this particular embodiment, the conduit 16 is a cylindrical sleeve. The seal 10 is similar to the seal of the first embodiment, the only difference being that a retainer is not required. Instead, the seal 10 is held in place by press-fitting the seal into the space between the conduit 16 and the cable 12. The tapered engagement portion 12 is held in place by friction. On the other hand, the seal could include a retainer 26 such as helical threads that will self-thread the inside surface of the conduit to assist in holding the seal in place.

FIG. 7 illustrates yet a further embodiment of the invention. In this embodiment, the seal 10 is made of two halves or body portions 36 and 38, similar to the above embodiment. However, in this embodiment, the two body portions 36 and 38 are interconnected by a hinge portion 50 so as to form a one-piece seal. In addition, the seal is preferably made out of a soft plastic such as a polypropylene copolymer and includes one or more internal ribs 52 that perform the sealing function of the O-ring 34, discussed above in regard to the other embodiments. The advantage of making the seal of a compliant material is that the separate O-rings can be eliminated in favor of the rib(s) which is part of the seal. Therefore, the entire seal can be formed of a single piece making the seal easier to use in the field where the space in the sewer is restricted and the light is minimal. Further, the compliant material allows the hinge to flex or bend repeatedly without breaking

In addition, polypropylene copolymers have a relatively low coefficient of thermal expansion relative to other polymer materials, such as PVC (polyvinylchloride) or LLDPE (linear, low density, polyethylene) compounds, or the like. For example, the coefficient of expansion of LLDPE and PVC is on the order of 8×10⁻⁵ (° C.⁻¹) below 0° C., whereas coefficient of thermal expansion of polypropylene materials is on the order of 2×10⁻⁵ (° C.⁻¹) at this temperature range. The fourfold reduction in the coefficient of thermal expansion for the polypropylene material is a substantial advantage. Further, since the coefficient of expansion for the stainless steel conduit is 2.5×10⁻⁵ (° C.⁻¹), the seal and the conduit expand and contract at substantially the same rate when the temperature changes.

In addition, although not required, the seal may include an alignment pin 54 on one of the body portions and an associated receiving hole 56 on the other body portion to assisting in aligning the two body portions during installation.

In the embodiment illustrated in FIG. 7, the retainer 26 includes a plurality or external ribs 58 for engaging the corrugations of the conduit 14. However, this embodiment of the invention is not intended to be limited to this particular retainer design. As discussed above with respect to the previous embodiments, the retainer may include external threads, rounded or V-shaped projections or the like. Alternatively, as with the embodiment illustrated in FIG. 6, the seal can include a tapered engagement portion that is held in place by friction, thereby eliminating the need for a retainer. The seal can then be use even if the conduit for the cable does not have corrugations.

Finally, the seal may include three or more body portions interconnected by hinges, instead of just two seal halves or body portions.

Having described the invention with particular reference to the preferred embodiments, it will be obvious to those skilled in the art to which the invention pertains after understanding the invention, that various modifications and changes may be made therein without departing from the spirit and scope of the invention as defined by the claims appended hereto. For example, although it is preferred that the engage portion be tapered, as shown in FIG. 1, the taper is not required.

What is claimed is:

1. A seal comprising:
a seal body including:
a base portion; and
an engagement portion attached to said base portion, said engagement portion being insertable into a space defined between a cable and a conduit surrounding the cable and having corrugations; and
a retainer disposed on said engagement portion for engaging at least one of said corrugations.

2. The seal of claim 1, wherein said base portion includes a groove extending circumferentially around an inner surface thereof.

3. The seal of claim 2, further comprising an o-ring retained in said groove.

4. The seal of claim 3, wherein said retainer comprises at least one thread disposed on said engagement portion for threadedly engaging said corrugations.

5. The seal of claim 3, wherein said retainer comprises at least one rib extending from said engagement portion.

6. The seal of claim 3, wherein said retainer comprises at least one protrusion extending from said engagement portion.

7. The seal of claim 3, wherein an outside surface of said engagement portion is tapered.

8. The seal of claim 3, wherein said seal body is made of two body halves.

9. The seal of claim 8, further comprising a clamp for circumscribing said base portion of each of said body halves to hold said body halves together.

10. The seal of claim 8, wherein said retainer comprises at least one thread disposed on said engagement portion for threadedly engaging said corrugations.

11. The seal of claim 8, wherein said retainer comprises a rib circumscribing said engagement portion.

12. The seal of claim 8, wherein said retainer comprises at least one protrusion extending from said engagement portion.

13. The seal of claim 8, wherein an outside surface of said engagement portion is tapered.

14. The seal of claim 3, wherein said seal body is plastic.

15. The seal of claim 8, wherein said seal body is plastic.

16. The seal of claim 9, wherein said seal body is plastic and said retainer is plastic.

17. The seal of claim 9, wherein said seal body is plastic and said retainer is metal.

18. The seal of claim 1, wherein said seal body includes two body portions and a hinge interconnecting said two body portions.

19. The seal of claim 18, wherein said seal defines an opening therein through which said cable passes and wherein said base portion of said seal body includes an internal rib that contacts said cable.

20. The seal of claim 19, wherein said seal is one-piece and made of polyvinylchloride.

21. The seal of claim 19, further comprising an alignment device for aligning said body portions when said body portions are pivoted with respect to said hinge to enclose said cable.

22. The seal of claim 21, wherein said alignment device includes a pin on one of said body portions and a hole in another of said body portions for receiving said pin.

23. A seal comprising:
a seal body having an engagement portion that is insertable into a space defined between a cable and a conduit surrounding the cable and having corrugations, said engagement portion being engageable with at least one of said corrugations.

24. The seal of claim 23, wherein said seal body has a groove extending circumferentially around an inner surface thereof for receiving an O-ring.

25. The seal of claim 23, wherein said seal body includes a plurality of body portions and a hinge interconnecting said body portions.

26. The seal of claim 25, wherein said seal body defines an opening therein through which said cable passes and includes an internal rib that contacts said cable.

27. The seal of claim 25, wherein said seal body is one-piece.

28. The seal of claim 27, further comprising an alignment device for aligning said body portions when said body portions are pivoted with respect to said hinge to enclose said cable.

29. The seal of claim 28, wherein said alignment device includes a pin on one of said body portions and a hole in another of said body portions for receiving said pin.

30. A seal comprising:
a seal body including:
a base portion; and
an engagement portion attached to said base portion, said engagement portion being tapered and being insertable into a space defined between a cable and a conduit surrounding the cable.

31. The seal of claim 30, wherein said seal body includes two body portions and a hinge interconnecting said two body portions.

32. A method of installing a cable in a conduit, comprising:
inserting the cable through the conduit such that the cable extends from at least one end of the conduit; and
positioning a seal in a space defined between the cable and the conduit at said one end to prevent contamination from entering into said space.

33. The method of claim 32, wherein said seal includes a retaining member and said conduit has corrugations, and wherein said positioning step includes securing said seal in said space by causing said retaining member to engage at least one of said corrugations.

34. The method of claim 33, further comprising the step of providing an O-ring inside said seal before said positioning step, said O-ring fitting snugly around said cable.

35. The method of claim 33, wherein said seal includes two halves that are separable from each other and wherein said method further comprises the step of positioning said seal halves around said cable prior to said positioning step.

36. The method of claim 33, wherein said seal includes a through-hole therein and wherein said positioning step includes the step of inserting said cable through said through-hole.

37. The method of claim 32, wherein said seal includes two body portions interconnected by a hinge and said method further comprises the step of placing said seal around said conduit by pivoting said body portions with respect to said hinge.

38. A conduit assembly comprising:
a conduit including a cable therein; and
a seal body having an engagement portion that is insertable into a space defined between the cable and the conduit surrounding the cable and having corrugations, said engagement portion being engageable with at least one of said corrugations.

39. The conduit assembly of claim 38, wherein said seal body has a groove extending circumferentially around an inner surface thereof for receiving an O-ring.

40. The conduit assembly of claim 38, wherein said seal body includes a plurality of body portions and a hinge interconnecting said body portions.

41. The seal of claim 40, wherein said seal body defines an opening therein through which said cable passes and includes an internal rib that contacts said cable.

42. The conduit assembly of claim 40, wherein said seal body is one-piece.
